(19) United States
(12) Patent Application Publication
(10) Pub. No.: US 2025/0229281 A1
(43) Pub. Date: Jul. 17, 2025

(54) MOLTEN REGOLITH DISPENSER GUN

(71) Applicant: Blue Origin Manufacturing, LLC, Huntsville, AL (US)

(72) Inventors: Garrett L. Schieber, Fort Wayne, IN (US); Patrick Michael McGarey, South Pasadena, CA (US); Alexander Imbault, Sierra Madre, CA (US); Eric D. Contreras, San Dimas, CA (US); Lauren Thomas Sagan, Los Angeles, CA (US); Vernon G. Harris, II, Los Angeles, CA (US)

(21) Appl. No.: 18/410,426

(22) Filed: Jan. 11, 2024

(51) Int. Cl. B05B 9/047; H05B 6/64

(52) U.S. Cl. CPC B05B 9/047; H05B 6/6491

(57) ABSTRACT

A method and system is presented for producing an extrusion of molten material that may be formed into an extended bead or filament. Among other possible applications, the extrusion of molten material may be used for constructing things, as in 3D printing or additive manufacturing, particularly if the extrusion is formed as an extended bead. In some implementations, the material may be lunar regolith that is melted by the system and extruded in a molten form, which subsequently cools to a solid on the surface(s) to which it is applied.

### BACKGROUND

Some of the key challenges of lunar colonization and other activities on the Moon are the cost and logistics of transporting materials from Earth to the Moon. To overcome this, scientists and engineers have been exploring the concept of in-situ resource utilization (ISRU), which involves using materials found on the moon to build infrastructure, produce fuel, and sustain life.

The moon's surface, or regolith, is rich in resources such as iron, aluminum, silicon, and oxygen. These materials may be extracted and processed to construct various things such as habitats, structures, solar panels, manufacturing equipment, and so on. Accordingly, research continues to concentrate on techniques for utilizing lunar resources.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic cross-section side view of a molten regolith dispenser gun, according to some embodiments.

FIG. 2 is a schematic cross-section side view of a molten regolith dispenser gun, according to other embodiments.

FIG. 3 is a schematic side view of functional components of a molten regolith dispenser gun, according to some embodiments.

FIG. 4 is a flow diagram of a process for melting and dispensing molten regolith, according to some embodiments.

### DETAILED DESCRIPTION

This disclosure describes, among other things, systems and methods for producing an extrusion of molten material that may be formed into an extended bead or filament. Among other possible applications, the extrusion of molten material may be used for constructing things, as in 3D printing or additive manufacturing, particularly if the extrusion is formed as an extended bead. In some implementations, the material may be lunar regolith that is melted by the system and extruded in a molten form, which subsequently cools to a solid on the surface(s) to which it is applied. Embodiments of the system as described herein are called a dispenser gun system, which is configured to controllably extrude molten material.

In some embodiments, the dispenser gun system may include a material chamber that includes a fill portion and a heating portion. The fill portion may be configured to receive unconsolidated material from a hopper or other input source, for example. The unconsolidated material may be material, such as regolith, that is crushed, granulated, or in a powder form, for example. The heating portion may be configured to receive and melt the material from the fill portion. The dispenser gun system may also include a nozzle for extruding the melted material. The combination of the relatively narrow opening of the nozzle and the viscosity of the melted material may likely call for the use of a plunger for pushing the received material so as to force the melt material into and through the nozzle to extrude the melted material. In various implementations, the plunger may remain separated from the melted material that is in the heating portion of the chamber. Such a separation may be maintained by unconsolidated material in the fill portion of the chamber, for example. Maintaining a separation between melted material and the plunger may be necessitated to avoid degradation of the plunger by exposure to the relatively high temperatures associated with the melted material, as explained below.

A dispenser gun system that dispenses or applies molten material in a controlled manner may be useful for 3D printing or robotic construction for automated processes of building structures using the molten material. For activities on the Moon, the material may be lunar regolith, for example. Such a system for dispensing or manipulating molten lunar regolith may provide a useful role for lunar exploration and in-situ resource utilization (ISRU). Herein, examples and discussions focus on methods performed with lunar regolith on the Moon. Even so, many of these example methods may instead be directed to applications performed on Earth or other bodies in the solar system. An important difference, however, is that atmospheric gases of the Earth, such as oxygen, may likely provide a disadvantage by accelerating degradation of refractory materials, whereas the Moon's vacuum provides an important advantage in this respect.

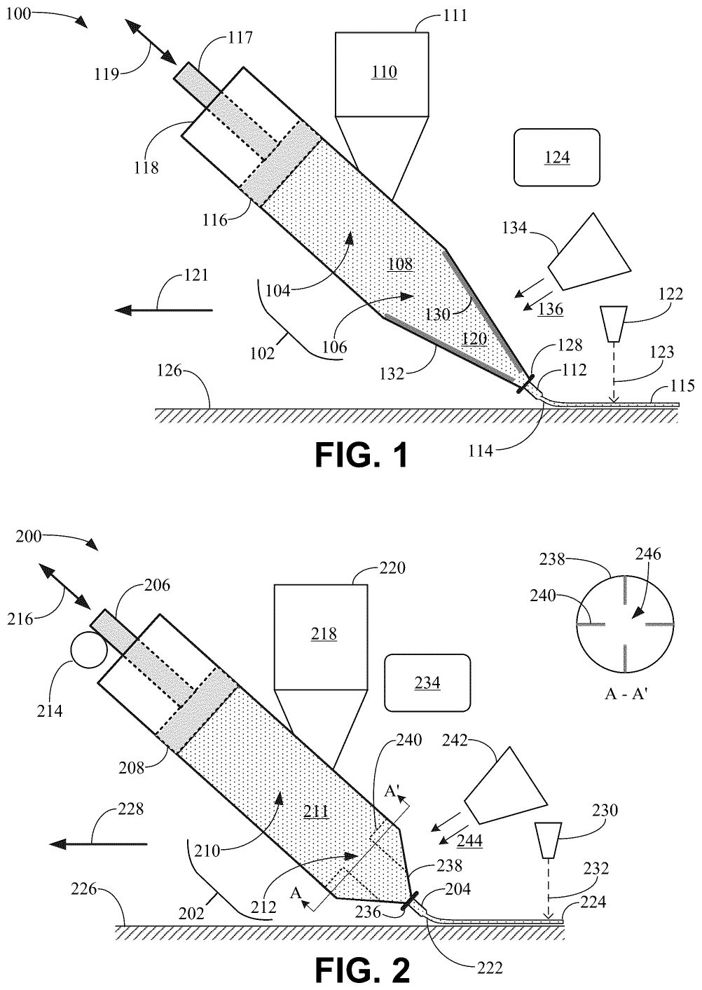

FIG. 1 is a schematic cross-section side view of a molten regolith dispenser gun system 100, according to some embodiments. System 100 may include a material chamber 102 that includes a fill portion 104 and a heating portion 106. In some implementations, as illustrated in FIG. 1, the fill portion and the heating portion may be contiguously and continuously joined to each other in the material chamber such that there is no well-defined border between them.

Generally, fill portion 104 may contain material that is relatively cool while heating portion 106 may contain the same material that is relatively hot. Fill portion 104 may be configured to receive unconsolidated material 108 from a hopper 110 or other input source, for example. Unconsolidated material 108, which may enter hopper 110 at an entrance 111, may be received in a crushed and/or powdered form. Heating portion 106 may be configured to receive and melt material 108 from fill portion 104. Thus, fill portion 104 may generally contain material 108 in a “frozen” state (e.g., physically in a solid state, though in an unconsolidated form) while heating portion 106 may generally contain material 108 in a melted (e.g., liquid) state. Hereinafter, “solid state” refers to the state of material that is non-melted, e.g., not in a liquid (melted) state, and is unconsolidated, e.g., in a crushed, granulated, or powdered form.

Dispenser gun system 100 may also include a nozzle 112 for extruding melted material 114 that may form a bead 115 in some implementations of system 100. In addition to shaping and sizing the extruded bead, nozzle 112 may be particularly beneficial for reducing the heat transfer length scale and thus increasing homogeneity of melt material 114. This may address the fact that unconsolidated packed beds of (regolith) particles generally have very low thermal conductivity. Reducing the heat transfer length scale may thus allow for a increased heat transfer efficiency. For at least the reason of the combination of the relatively narrow opening of nozzle 112 and the viscosity of the melted material, a plunger 116 may be used for pushing material received into fill portion 104, which in turn pushes and forces the melted material into and through nozzle 112 to extrude the melted material. A shaft 117 securely supports plunger 116 and slidably penetrates an end 118 of chamber 102 to adjust the position of plunger 116 in chamber 102, as indicated by arrow 119.

In various implementations, plunger 116 may be separated from melted material 120 in heating portion 106 by material 108 in fill portion 104 of the chamber. Material 108, before it has moved into heating portion 106, is relatively cool and in a solid (though unconsolidated) state. Material 108, in an unconsolidated state, likely has a relatively low thermal conductivity (e.g., low bulk thermal conductivity), particularly if the material is lunar regolith, and more particularly if the material is lunar regolith in a vacuum, for example. Accordingly, material 108 between plunger 116 and hot melted material 120 provides thermal insulation to protect plunger 116 and other portions of system 100 from relatively high temperatures that could otherwise degrade the plunger.

In various implementations of dispenser gun system 100, melted material extruded from nozzle 112 may be in the form of a filament or extended (e.g., elongated) bead 115, similar to a bead shape that is produced by a caulking gun, for example. Thickness of bead 115 may be varied by adjustments to opening size in nozzle 112, adjustments to the viscosity of melted material 120, such as by changing its temperature, adjustments to the rate of plunger 116 as it compresses the material in chamber 102, and adjustments to the speed of travel, indicated by arrow 121, of system 100, just to name a few examples. In some embodiments, dispenser gun system 100 may include an image sensor 122 to capture images or video of extruded melt material 114 and/or bead 115 below, as indicated by arrow 123. A flow controller 124, described in detail below, of system 100 may be configured to adjust the flow rate of extruded melt material 114 based, at least in part, on the images or video captured by image sensor 122. For example, via image recognition processes, an image captured by image sensor 122 may indicate that bead 115 formed from extruded melt material 114 on a surface 126 is thinner or thicker than desired for a particular application. Accordingly, flow controller 124 may do one or more of the following to change the flow rate of extruded melt material 114: adjust the viscosity of melted material 120 by changing its temperature; adjust the inward or outward rate of motion or position of plunger 116; and/or adjust a nozzle valve 128. In some implementations, nozzle 112 may have a size-adjustable opening and this may allow for yet another method for changing the size of bead 115. In other implementations, nozzle 112 may be interchangeable with other nozzles having different opening sizes. It is worth noting that ambient temperatures immediately outside nozzle 112, such as temperature(s) of surface 126 and its immediately-surrounding space (except in the vacuum of the Moon), may likely affect the size of bead 115. Accordingly, in some implementations, temperature(s) in a region outside and adjacent to nozzle 112 may be controllable by system 100, as described below.

Any of a number of heating techniques may be used, such as resistive heating, solar heating, induction heating, and microwave heating. For example, in some embodiments, heating portion 106 of system 100 may include a microwave susceptor material 130 that may be on or in wall(s) 132 of heating portion 106. In some implementations, the microwave susceptor material may be in the form of fins located in heating portion 106. Such fins, which may instead comprise other materials, are illustrated in FIG. 2. A microwave emitter 134 may be outside and adjacent to heating chamber 106. In some implementations, wall(s) 132 may comprise a material that is at least partially transparent to microwaves 136 and in other implementations microwaves 136 may be emitted from within material chamber 102 or from an emitter(s) directed inward and in wall(s) 132. A goal of either of these implementations is to enable the microwaves to reach susceptor material 130 and/or material 108 in heating chamber 106 (e.g., melted material 120 in heating portion 106).

In some embodiments, heating portion 106 of system 100 may include induction heating to apply heat to material 108 and/or melted material 120 in the heating portion. In some implementations, heating portion 106 may include fins such as those illustrated in FIG. 2, as described below. The fins may be configured to conduct heat from the induction heating to material 108 and/or melted material 120 in various parts of heating portion 106.

In some implementations, system 100 may be configured to dispense and form two (or more) beads 115 substantially in parallel with each other on surface 126. In some configurations, though not illustrated, two parallel nozzles may receive melted material 120 from heating portion 106.

FIG. 2 is a schematic cross-section side view of a molten material dispenser gun system 200, according to some embodiments. System 200 may include a chamber 202 having a nozzle 204 at a first end of the chamber, and a shaft 206 with a plunger 208 attached thereto. Shaft 206 may enter chamber 202 at a second end of the chamber opposite the first end. System 200 may further include a receiving (e.g., fill) portion 210 of the chamber to receive and temporarily store an unconsolidated material 211, such as regolith, in a solid (e.g., frozen) state. The receiving portion may be adjacent to plunger 208. System 200 may further comprise a heating portion 212 between nozzle 204 and receiving portion 210. Heating portion 212 may be configured to receive and melt the material (e.g., regolith) to produce the molten material. Plunger 208 may be configured to be separated from the molten material by material in its non-molten solid state in receiving portion 210 of the chamber.

System 200 may further include an actuator 214 to move, via shaft 206, the position of the plunger so as to displace both the material in its solid state and the molten material and force the molten material into and through nozzle 204. Motion imparted to shaft 206 by actuator 214 is indicated by arrow 216, for example, and plunger 208 follows the same motion. Generally, during operation of system 200 (and 100), plunger 208 moves downward into chamber 202 to push unconsolidated material 211 downward to where it is melted and extruded. As unconsolidated material 211 is consumed by the process, plunger 208 may be pulled upward and out of the way of a material entrance from a hopper 218. With plunger 208 out of the way, more unconsolidated material 211 may be added to recharge chamber 202. Subsequently, plunger 208 may again be forced downward to push the new material into heating portion 212 and through nozzle 204.

Generally, receiving portion 210 may contain material that is relatively cool while heating portion 212 may contain material that is relatively hot. As mentioned above, receiving portion 210 may be configured to receive unconsolidated material 211 from hopper 218 or other input source, for example. Unconsolidated material 211, which may enter hopper 218 at an entrance 220, may be received in a crushed and/or powdered form. Heating portion 212 may be configured to receive and melt unconsolidated material 211 from receiving portion 210. Thus, receiving portion 210 may generally contain unconsolidated material 211 in its “frozen” state while heating portion 212 may generally contain material 211 in a melted (e.g., liquid) state.

In some implementations of system 200, nozzle 204 may extrude melted material 222 that may form a bead 224 on a surface 226. The combination of the relatively narrow opening of nozzle 204 and the viscosity of the melted material may call for the use of plunger 208 for pushing material received into receiving portion 210, which in turn pushes and forces the melt material into and through nozzle 204 to extrude the melted material.

In various implementations, plunger 208 may be separated from material that is melted in heating portion 212 by material 211 in receiving portion 210 of the chamber.

As described above for system 100, thickness of bead 224 may be varied by adjustments to opening size in nozzle 204, adjustments to the viscosity of melted material, such as by changing its temperature, adjustments to the rate of plunger 208 as it compresses the material in chamber 202, and adjustments to the speed of travel, indicated by arrow 228, of system 200, just to name a few examples. In some embodiments, dispenser gun system 200 may include an image sensor 230 to capture images or video of extruded melt material 222 and/or bead 224 below, as indicated by arrow 232. A flow controller 234 of system 200 may be configured to adjust the flow rate of extruded melt material 222 based, at least in part, on the images or video captured by image sensor 230. For example, flow controller 234 may do one or more of the following to change the flow rate of extruded melt material 222: adjust the viscosity of melted material by changing its temperature; adjust the inward or outward rate of motion or position of plunger 208; and/or adjust a nozzle valve 236. In some implementations, nozzle 204 may have a size-adjustable opening and this may allow for yet another method for changing the size of bead 224. In other implementations, nozzle 204 may be interchangeable with other nozzles having different opening sizes.

In some embodiments, heating portion 212 of system 200 may include a microwave susceptor material that may be on or in wall(s) 238 of heating portion 212. In some implementations, the microwave susceptor material may be in the form of fins 240 located in heating portion 212. Microwaves may be emitted from within material chamber 202 or from an emitter(s) directed inward and in wall(s) 238. In some implementations, a microwave emitter 242 may be outside and adjacent to heating portion 212. Wall(s) 238 may comprise a material that is at least partially transparent to microwaves 244 so that the microwaves can reach susceptor material (e.g., fins 240) in heating chamber 212. A closeup view across section A-A′ is included in the right of FIG. 2. A center region 246 of heating portion 212 coincides with a central flow of molten material heading toward nozzle 204. Fins 240 may extend from wall(s) 238 of the heating portion 212.

In some embodiments, heating portion 212 of system 200 may include induction heating to apply heat to material 211 in heating portion 212. In some implementations, fins 240 in heating portion 212 may be made of a material configured to conduct heat from the induction heating to material 211 in various parts of heating portion 212.

In some embodiments, as illustrated, chamber 202 is conically shaped at heating portion 212 to concentrate material flow toward and into nozzle 204. The cone shape may be relatively broad, as compared to the cone shape of heating portion 106 of system 100, for example, because fins 240 allow heat to reach interior parts of heating portion 212. Without such fins, the cone shape may be angled to form a heating portion that is relatively narrow, such as for system 100. This reduces distances that heat generated by induction heating at wall(s) 238 (or just beyond the wall(s)) must travel to reach all parts of the interior of heating portion 212.

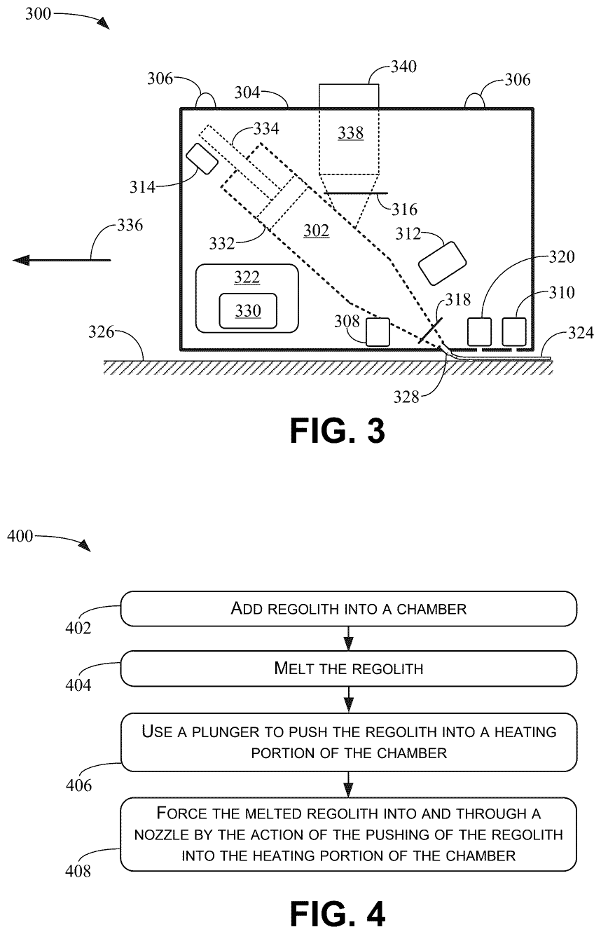

FIG. 3 is a schematic side view of functional components of a molten regolith dispenser gun system 300, according to some embodiments. System 300 may include a dispenser gun 302, which may be similar to or the same as that of systems 100 or 200. An enclosure 304 may surround and at least partially contain dispenser gun 302 and other components of system 300 that are described below. Enclosure 304 may include attachment points 306 for affixing system 300 to a vehicle or other moveable object such as an arm that is part of an X-Y positioning system for 3D printing, for example.

System 300 may further include a temperature sensor 308, an image sensor 310, a microwave emitter 312, a plunger actuator 314, a hopper valve 316, a nozzle valve 318, a temperature regulator 320, and a processor 322. Temperature sensor 308 may include one or more transducers to measure the temperature of material in one or more locations in dispenser gun 302. For example, a temperature transducer, depending at least in part on where it is located, may be a pyrometer or a thermal couple, just to name a few examples. Temperature measurements may be provided to processor 322.

Image sensor 310 may be focused on a portion of bead 324 to capture images or video of the bead continuously (e.g., video) or from time to time. Bead 324 may be formed on a surface 326 from melted material that is extruded by a nozzle 328 of dispenser gun 302. The temperature of the extruded melted material may be adjusted, as described below, to be in a molten state, a plastic state, or a solid state at various distances from nozzle 328. The rate of flow from nozzle 328, in coordination with the shape and size of the nozzle opening, may affect the size and shape of bead 324 of molten material as it cools on surface 326. Accordingly, processor 322, which may include a flow controller 330 (e.g., the same as or similar to 124), may be configured to adjust the flow rate of extrusion of the melted material based, at least in part, on the images or video captured by image sensor 310. For example, processor 322 may perform image recognition of one or more images captured by image sensor 310 to determine if bead 324 formed from the extruded melt material is thinner or thicker than desired for a particular application. In some implementations, processor 322 may access a database of images of beads and compare those images with images captured in real-time by image sensor 310. Accordingly, flow controller 330 may do one or more of the following to change the flow rate of extruded melt material: adjust the viscosity of the melted material before it is extruded from nozzle 328 by changing the temperature of the melted material in various locations in dispenser gun 302; adjust the inward or outward rate of motion or position of plunger 332 by controlling the action of plunger actuator 314 on shaft 334 of the plunger; adjust the speed of travel, indicated by arrow 336, of system 300; adjust nozzle valve 318; and/or adjust hopper valve 316 to control the rate of material flow from hopper 338 or a material input port 340. Still another technique or process for adjusting the size or other characteristics (e.g., thickness, width, albedo, temperature (e.g., via blackbody spectral measurements by image sensor 310), and surface roughness) of bead 324 may be to use temperature regulator 320 to at least partially control the temperature of the melt material extruded from nozzle 328. For example, temperature regulator 320 may be configured to apply infrared radiation (which transmits through vacuum) to bead 324 to increase the temperature of the bead. Such a temperature increase may affect the shape of the bead by reducing the viscosity of the extruded melted material and/or by maintaining the melted material in a liquid state for an increased amount of time.

FIG. 4 is a flow diagram of a process 400 for melting and dispensing molten regolith, according to some embodiments. The process, which may involve material other than regolith, may be performed by an operator, which may be a person or persons, a computer processor executing computer-readable code, or a combination thereof. For example, the computer processor may be the same as or similar to processor 322 and flow controller 330 (or 124) may be an example of computer-readable code. Process 400 may be performed by the operator using a system that is the same as or similar to any of systems 100, 200, or 300. Accordingly, for the present example, process 400 is described using system 100. Though the following process description involves producing and placing a single bead on a surface, two or more beads may be produced and placed by a process similar to or the same as process 400. Claimed subject matter is not limited in this respect.

At 402, the operator may add regolith via entrance 111 into hopper 110. The addition of regolith may at least partially fill chamber 102. In particular, heating portion 106 may be substantially filled within wall(s) 132 while fill portion 104 may be filled up to or below a level of chamber 102 where plunger 116 is located. At 404, the operator may melt the regolith that is in heating portion 106 by induction heating or by applying microwaves 136 to susceptor material in the heating portion. At 406 and 408, the operator may use plunger 116 to push the regolith that is in fill portion 104 into heating portion 106, which happens as regolith that has melted in the heating portion is pushed into and through nozzle 112. In other words, un-melted regolith in fill portion 104 replaces melted regolith in the heating portion as the melted regolith in the heating portion exits via the nozzle.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A dispenser gun system for controllably extruding molten material, the dispenser gun system comprising:
a material chamber including a fill portion and a heating portion, wherein
the fill portion is configured to receive unconsolidated material, and
the heating portion is configured to melt the received unconsolidated material into melted material;
a nozzle for extruding the melted material; and
a plunger for pushing the received unconsolidated material so as to force the melted material into and through the nozzle to extrude the melted material, wherein the plunger is separated from the heating portion by the fill portion.

2. The dispenser gun system of claim 1, wherein the melted material is lunar regolith.

3. The dispenser gun system of claim 1, wherein the fill portion and the heating portion are contiguously joined to each other in the material chamber.

4. The dispenser gun system of claim 1, wherein the extruded melted material is in the form of a filament or bead.

5. The dispenser gun system of claim 1, wherein the fill portion is configured to receive the unconsolidated material in a crushed and/or powdered form.

6. The dispenser gun system of claim 1, wherein the heating portion of the material chamber includes a microwave susceptor material.

7. The dispenser gun system of claim 6, wherein the microwave susceptor material is in the form of fins located in the heating portion of the material chamber.

8. The dispenser gun system of claim 6, wherein walls of at least a part of the heating portion of the material chamber comprise the microwave susceptor material.

9. The dispenser gun system of claim 1, wherein the heating portion of the material chamber includes induction heating to apply heat to the received unconsolidated material.

10. The dispenser gun system of claim 9, further comprising heat conducting fins located in the heating portion of the material chamber, wherein the heat conducting fins are configured to heat by the induction heating.

11. The dispenser gun system of claim 1, further comprising an image sensor to capture images or video of the extruded melted material.

12. The dispenser gun system of claim 11, further comprising a flow controller to adjust flow rate of the extruded melted material based, at least in part, on the images or video captured by the image sensor.

13. The dispenser gun system of claim 11, further comprising a flow controller to adjust flow rate of the extruded melted material by adjusting a position of the plunger.

14. The dispenser gun system of claim 1, further comprising attachment points to enable the dispenser gun system to attach to a moveable arm or vehicle for a 3D printing or additive manufacturing process.

15. A system for dispensing a continuous bead of molten regolith onto a surface, the system comprising:
a chamber having a nozzle at a first end of the chamber;
a shaft with a plunger attached thereto, the shaft entering the chamber at a second end of the chamber opposite the first end;
a receiving portion of the chamber to receive and temporarily store unconsolidated regolith in its solid state, the receiving portion adjacent to the plunger;
a heating portion of the chamber between the nozzle and the receiving portion, the heating portion configured to receive and melt the unconsolidated regolith to produce the molten regolith, wherein the plunger is configured to be separated from the molten regolith by the unconsolidated regolith in its solid state in the receiving portion of the chamber; and
an actuator to move, via the shaft, the position of the plunger so as to displace the unconsolidated regolith in the solid state and the molten regolith and force the molten regolith into and through the nozzle.

16. The system of claim 15, wherein the receiving portion and the heating portion are contiguously joined to each other in the chamber.

17. The system of claim 15, wherein the regolith in its solid state is in a crushed and/or powdered form.

18. The system of claim 15, wherein the heating portion of the chamber includes a microwave susceptor material.

19. The system of claim 18, wherein the microwave susceptor material is in the form of fins located between the nozzle and the heating portion of the chamber.

20. The system of claim 18, wherein walls of at least a part of the heating portion of the chamber comprise the microwave susceptor material.
